(19) United States
(12) Patent Application Publication
(10) Pub. No.: US 2007/0187377 A1
(43) Pub. Date: Aug. 16, 2007

(54) Welding device control

(76) Inventors: Markus Pernegger, Eberstalzell (AT); Manuel Rumpl, Sipbachzell (AT)

Correspondence Address: WILLIAM COLLARD;COLLARD & ROE, P.C., 1077 NORTHERN BOULEVARD, ROSLYN, NY, 11576, US

(21) Appl. No.: 10/591,805

(22) PCT Filed: Mar. 4, 2005
(86) PCT No.: PCT/AT05/00069

§ 371 Date: Jan. 9, 2007

(30) Foreign Application Priority Data
Mar. 9, 2004 (AT) A A 401/2004

(51) Int. Cl. B23K 9/10

(52) U.S. Cl. 219/130.5

(57) ABSTRACT

The invention relates to a device and a method of controlling a welding apparatus (1), whereby individual welding parameters can be set in the form of a welding job (35 to 39) by means of a first control unit (22) hard-wired to or integrated in the welding apparatus (1), and several such welding jobs (35 to 39) can be stored in a memory device (28) and, by selecting a welding job (35 to 39) by means of the first control unit (22), the welding apparatus (1) and the components of the welding system are activated on the basis of the parameters stored therein by a control system (4), and when a second control unit (29) is operated, a start signal is sent to the control system (4) in order to start the welding operation. The start signal or a control signal is thus generated by the push-button element (30) of the second control unit (29) and, before the welding operation is started, a selection or switch is made between the individual stored welding jobs (35 to 39) by means of the control signal and/or if the start signal is generated by means of the same push-button element (30), a start-up of the welding operation is run.

The invention relates to a method of controlling a welding apparatus, whereby individual welding parameters, such as current intensity, a rod feed rate, a welding process, a frequency and/or a pulse duration welding current etc., can be set up by the user in the form of a welding job for a specific welding process by means of a first control unit hard-wired to or integrated in the welding apparatus, and several such welding jobs can be stored in a memory device, and when a welding job is selected by means of the first control unit, the welding apparatus is activated on the basis of the parameters stored therein by means of control system, in particular a microprocessor controller, and the components of the welding system such as a power component, a rod feed systems or a rod feed device, etc., are activated, and when a second control unit is operated, in particular a push-button element disposed on the welding torch, a start signal is sent to the control system in order to start the welding operation, and the invention further relates to a control system for a welding apparatus, comprising a first control unit, a microprocessor controller with a memory device and a power component, and the different parameters can be set up in the form of welding jobs by means of the first control unit and the welding apparatus activated on the basis of these parameters by the power component, and a second control unit disposed on the torch of the welding apparatus hard-wired to the microprocessor controller, on which a push-button element is disposed for generating a start signal, and the use of the method for controlling a MIG, MAG or WIG welding apparatus.

Many demands are made of modern welding apparatuses these days. In order to achieve optimum weld seam quality, it is often necessary to set and take into account a plurality of parameters, such as the welding current, its pulse time and frequency, the associated welding rod diameter and the appropriate rod feed rate as well as start-up and ignition operations of the arc and similar parameters specifically adapted to the welding process, each of which must be selected specifically for the material to be welded and the respective component geometry. Apart from an exact knowledge of the welding process, it is also necessary to have a facility for setting these values.

Methods and devices for controlling and setting these welding parameters are already known, whereby some process data can be pre-set and stored by means of a microprocessor controller and an appropriate input-output device, and can be transmitted by means of a control system to the power component of the welding apparatus as and when necessary to enable a welding process to be run on the basis of these parameters. For example, patent specification DE 196 02 876 C2 discloses a method and a device for controlling a WIG-welding apparatus, by means of which the parameters to be varied are pre-selected from a control system and these parameters can be influenced during the welding process by means of a push-button on the torch provided specifically for this purpose. Using selection elements of the control system, individual parameters can also be directly retrieved and changed, after which they remain available to the welding program again.

The disadvantage of the systems known from the prior art is that there is only a small degree of flexibility in the way in which the welding process can be influenced. For example, in order to change the parameters from the welding torch, it is necessary to use a separate or several separate push-buttons provided specifically for this purpose.

The underlying objective of the present invention is to propose a method and a device for controlling a welding apparatus, enabling welding parameters to be set and selected easily and rapidly for a varied range of requirements. Another objective of the invention is to propose as simple and efficient as possible a construction of the welding torch to be connected to the welding apparatus.

This objective is achieved by the invention, independently in each case, on the basis of a method of the type outlined above, whereby the start signal or a control signal is generated by the push-button element of the second control unit, in other words of the welding torch, and, prior to the start of the welding operation, a selection or switch can be made between the individually stored welding jobs on the basis of the control signal and/or start-up of the welding operation can be initiated by generating the start signal by means of the same push-button element, and by means of a control system, whereby the microprocessor controller has an element for evaluating a control signal generated by the second control unit prior to start-up of the welding operation, and the second control unit for switching the welding jobs and initiating the welding process is nothing more than the push-button element. The advantage of this is that it is now possible for the user simply to select a plurality of welding parameters needed for an optimum welding result and specifically adapted to the respective welding process and adapted to factors pertaining to the material and geometry of the materials to be welded prior to the start of the welding operation by means of a simple push-button element. Since nothing more than a push-button element is needed, a standard and inexpensive one-button torch can be used, thereby offering a high degree of reliability due to the simple construction. The fact that a welding torch with only one push-button element is used also means that the design of the welding plant, in other words the design of the connection between the welding apparatus and the welding torch, is very much simplified and the welding torch can be connected to any standard welding apparatus in the usual way, whereas the systems known from the prior art require special fittings with special welding torches, in other words welding torches with several push-button elements for several functions, which can always be used with specially adapted welding apparatus only. Furthermore, the risk of incorrect operation such as can occur using torches with several buttons is reduced to a minimum. In order to select the welding jobs, the parameters needed for the desired welding jobs can firstly be set up and stored in the memory device at the welding apparatus itself by means of the first input device, in other words the one integrated in the welding apparatus. The user is able to do this for a plurality of welding processes and welding jobs and for different conditions, such as different sheet thicknesses or materials or other requirements, for example. Prior to the start of the welding operation, it is now possible to initiate the welding operation with the parameters of the current welding job or to select another welding job by means of an appropriate control sequence at the welding torch. The requisite welding parameters can be selected rapidly and easily by inputting from the second control unit disposed on the welding torch, without the user firstly having to waste time and effort going across to the welding apparatus, and the user can select the welding job and start the welding operation with only one push-button element. This may be necessary when changing the welding process or the weld position or if it is necessary to manipulate the workpiece to be welded in order to change the wall thickness or the material of the workpiece, as a result of which it becomes necessary to adapt the welding current and the rod feed rate, for example. This also means that the concentration or work rate of the welder is barely affected, because he does not have to set down the torch and any other tool and does not have to look away from the welding point. In addition to the time advantage gained, the operational safety and quality of the welding process are increased. Furthermore a user can quickly and easily set up personally preferred welding parameters, such as a rod feed rate that is best for him, by selecting the corresponding welding job, and several users can therefore use the same welding machine without having to set up changes at the welding apparatus itself. Another advantage is the fact that an unintentional, incorrect setting of individual welding parameters which would not be suitable for the current job or which would result in poorer quality or a tiresome and lengthy selection of specific parameters correlated to other parameters is avoided. It is necessary to set the parameters once only in order to set up the entire welding job.

In one embodiment, the parameters for an individual welding job are organized in parameter groups and the different welding jobs are stored in the memory device in a fixed sequence so that a welding job and its parameters can be clearly distinguished from another welding job, and the user can select the welding job he desires through standard operating sequences. This makes it very easy for the user to control the welding apparatus.

The welding jobs can be stored in the memory device so that they are clearly identifiable, thereby making it possible to select a specific parameter group and hence a specific welding job by an appropriate input directly at the second control unit in a simple and rapid manner, on the one hand, and a sequence of welding jobs needed for welding can advantageously be defined in the memory device by means of this defined numbering of the individual welding jobs, on the other hand, which can then by switched or selected by the user on the basis of a simple control sequence at the second control unit.

Another advantageous feature is one whereby the welding jobs are grouped in individual job groups from which at least one welding job can be retrieved, because this enables different parameter settings to be grouped in different welding jobs compactly and clearly for different welding processes, for example for a MIG welding process or a pulsed welding process, so that the user is able to select the desired welding job easily and rapidly.

It is also of advantage if the job groups containing one or more welding jobs are stored in the memory device separated from one another by empty groups or empty jobs, in other words a welding job in which no parameters have been set, or the last welding job at the end of a job group is stored in the memory device with an indicator for a separator signal, because this enables several related parameter groups or welding jobs to be stored together, thereby facilitating selection of the welding jobs, because if a totally different welding process is to be used, the parameter groups that are not appropriate can be easily skipped during the selection, thereby making it easy to activate the appropriate welding job rapidly. Providing an empty job also offers a simple, user-friendly setting option at the end of a job group. Using an indicator also saves on memory resources.

The advantage of another embodiment in which the curve of the output signal of the push-button, in particular the push-button element is used as a means of defining the control signal and the start signal on the basis of its frequency and/or duration, is that a plurality of different control signals can also be generated with just one push-button, thereby enabling a comprehensive or very variable control of the welding apparatus. This results in a very inexpensive design of the welding torch and simultaneously offers a very high degree of operating safety due to the very simple design of the welding torch.

Another option is to run a comparison between the output signal generated by the push-button or push-button element with several curves previously set and stored in the memory device representing possible control signals and the start signal based on their frequency and/or duration, thereby achieving a high degree of control flexibility, because it is then possible to assign a desired function or effect to an output signal generated by the user so that the welding apparatus can be set up to reflect the control habits of the respective user, and new control sequences are not needed when changing models, thereby avoiding operating errors which might have been learned and then have to be unlearned.

The fact that the start signal for initiating the welding process is defined by depressing the push-button for longer than the control signal used to select the welding job advantageously means that unintentional start-up of the welding operation is avoided.

By virtue of another option, an appropriate control signal, in particular a brief depression of the push-button element, enables the next welding job stored in the sequence to be selected from the memory, thereby making it possible to switch easily between or select the parameter groups or welding jobs stored in the memory device. The user can therefore select the appropriate welding job simply by retrieving jobs in succession, in other words by depressing the push-button element several times.

On an appropriate control signal, after the last welding job stored in the memory device, the first welding job stored in this job group is selected, the advantage of which is that after running through all the parameter groups or welding jobs stored in the memory device, the status of the welding apparatus can not be re-set directly at the apparatus and instead, it is possible to continue welding immediately. Accordingly, this also gives the user the option of retrieving a previous welding job easily because he merely has to depress the push-button element briefly several times in order to move back to this welding job.

By virtue of another option, on an appropriate control signal, in particular when the push-button element is depressed for a medium-length of time, the next job group in the sequence in the memory device following the next empty group or empty job is selected, thereby making it easy to change the welding process by skipping whole associated parameter groups or welding jobs which were defined for a specific welding process, thereby making it easy to continue with the other welding process incorporating other jobs quickly and efficiently.

Likewise on an appropriate control signal, the next job group in the sequence in the memory device following the preceding empty group is selected, thereby making it possible to switch easily between different parameter groups or welding jobs demarcated by two empty groups in the memory device in order to select a specific welding process several times, for example.

Due to the fact that the first job group stored in the memory device is selected on an appropriate control signal, the first welding job stored in the memory unit can be selected at the control system irrespective of the parameter group just selected, without the bother of having to switch through the individual parameter groups.

Also of advantage is an embodiment whereby any number of welding jobs can be defined in a job group by a user and likewise any number of job groups with a different number of welding jobs stored in them can be set up by the user, because this enables additional welding jobs to be stored by the user at any time.

In one embodiment, the microprocessor controller runs a check on the selected welding jobs with regard to the threshold values to be complied with for the individual parameters and if necessary, the first and/or second control unit emits a visual and/or acoustic warning message, thereby resulting in high operating safety and preventing the individual parameters from being entered incorrectly, which prevents incorrect welding and damage to the workpiece, thereby saving on costs. This also means that the user does not have to run test welds.

Another advantage is the fact that the parameters or the parameter group of the respective welding job selected are displayed by the first and/or second control unit because the user is able to check the selection quickly and easily, thereby prevent welding errors.

It is also possible to select from and switch between the individual welding jobs during a welding operation on the basis of the control signal generated by the second control unit, the advantage of which his that a lower or higher current and the appropriate feed rate of the rod can be set in the event of a changing sheet thickness, for example, without having to stop, thereby enabling the entire weld seam to be completed without interruption in one work operation and thus saving on time.

In another embodiment of the control system, the welding parameters for the welding jobs are stored in the memory device together in parameter groups, the advantage of which is that the grouping makes it easy to select the different welding jobs or make changes and store them. This is also of advantage if specific welding processes have to be repeated at later points in time because these groups are already stored and merely have to be selected again and do not have to be re-programmed.

Due to the fact that the individual welding jobs are separated from one another by empty groups, it is possible to identify and thus select associated parameter groups and welding jobs easily.

In another embodiment, the second control unit additionally has a visual output device for warning messages and/or information so that additional information can be displayed to the user and used to check the parameters that have been set, and if any of the set parameters are incorrect, a warning message can be displayed directly at the second control unit in order to alert the user. Another major advantage is that the user can tell whether the welding apparatus has switched to a different welding job.

The visual output device may be provided in the form of one or more control lamps, for example LEDs, thereby resulting in a robust and inexpensive design of the visual output device whilst simultaneously keeping weight to a minimum.

If the visual output device is provided in the form of a display, for example an LCD, the user can be presented with comprehensive information, for example about the current welding process or welding job.

The second control unit, in particular the welding torch, may be connected to the control system by means of a two-terminal electric cable, the advantage of which is that an inexpensive and simple connection of the two components can be achieved, thereby reducing susceptibility to faults and hence keeping costs to a minimum.

In another embodiment, the first control unit has an input device, for example in the form of a key pad, and a visual and/or acoustic output device, for example in the form of a display, for warning messages and/or information, and is hard-wired to the microprocessor controller, which means that the different parameter groups and welding jobs can firstly be conveniently set up at the welding apparatus itself and their sequence pre-defined, or parameter groups and welding jobs already defined earlier can be easily retrieved or loaded for the user, thereby making welding operations reproducible.

In another variant, the first control unit and the microprocessor controller are connected via an appropriate interface by means of a standard computer which is separate from the welding apparatus, in which case all of the controls can be operated at the welding apparatus with the operating convenience and options offered by standard computers, thereby simplifying further processing and retrieval of the requisite parameters.

The invention further relates to the use of the method for controlling a MIG, MAG or WIG welding apparatus.

To provide a clearer understanding, the invention will be explained in more detail below with reference to the appended drawings.

Of the schematically simplified diagrams:

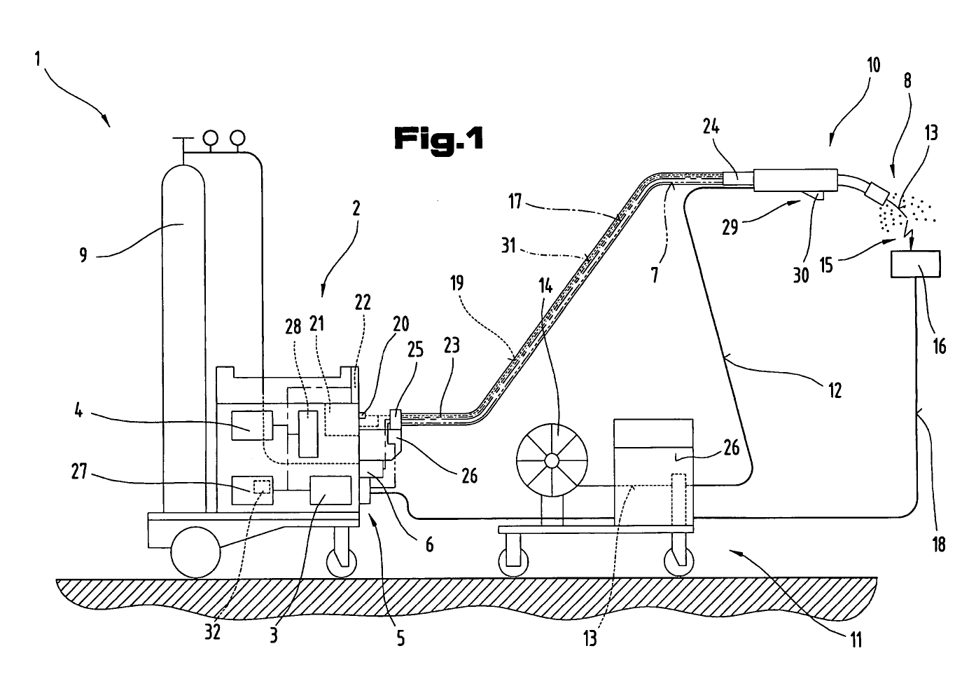

FIG. 1 is a schematic illustration of a welding apparatus for running a variety of welding processes;

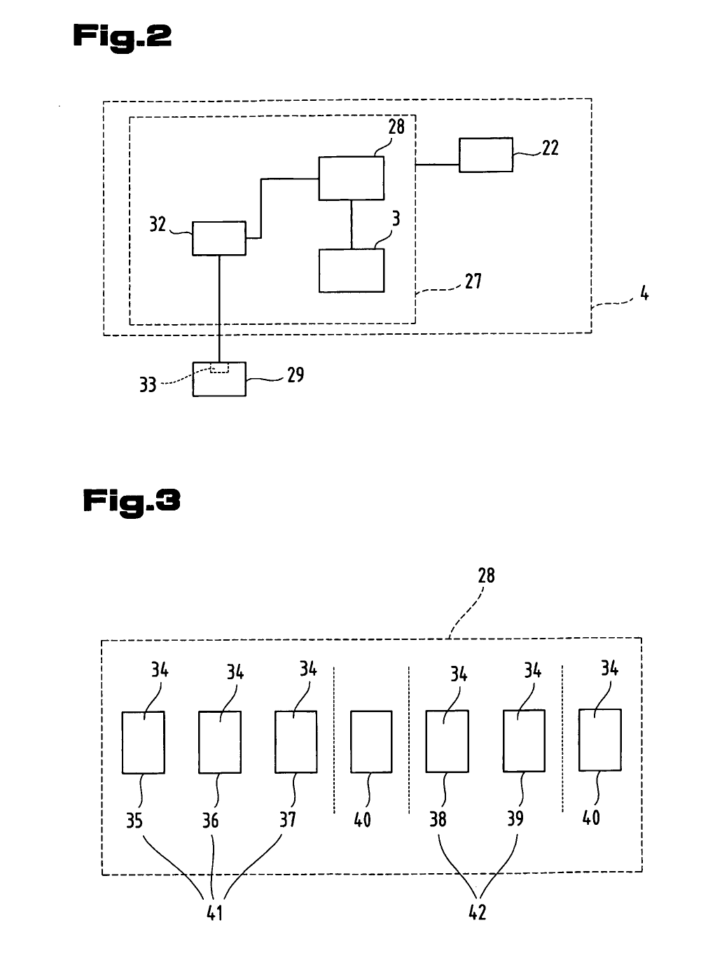

FIG. 2 is a block diagram of the control system;

FIG. 3 is a memory diagram of the memory device.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc,. relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIG. 1 illustrates a welding apparatus 1 or welding system for carrying out a whole range of methods and processes, e.g. MIG-MAG welding and TIG/WIG welding or electrode welding processes, double rod/tandem welding processes, plasma welding or soldering, etc.

The welding apparatus 1 comprises a current source 2 with a power component 3, a control system 4 and a switching element 5 co-operating with the power component 3 and control system 4. The switching element 5 or the control system 4 is connected to a control valve 6 incorporated in a supply line 7 for a gas 8, in particular an inert gas such as CO₂, helium or argon and such like, running between a gas storage 9 and a welding torch 10 or blow-pipe.

Furthermore, a wire feed device 11 such as commonly used for MIG-MAG welding may also be activated via the control system 4 in order to feed a welding rod 13 from a supply reel 14 through a supply line 12 into the region of the welding torch 10. Clearly, the rod feed device 11 could also be integrated in the welding apparatus 1, in particular in the basic housing, in a manner known from the prior art, rather than used as an add-on device as illustrated in FIG. 1.

The rod feed device 11 could also feed the welding rod 13 or additional material to the processing point externally to the welding torch 10, in which case a non-fusing electrode is preferably provided in the welding torch 10, as is standard practice in the case of WIG/TIG welding.

The current needed to strike an arc 15, in particular a working arc, between the electrode and a workpiece 16 is fed via a welding line 17 from the power component 3 of the current source 2 to the welding torch 10, in particular the electrode, and the workpiece 16 to be welded, which may be made up of several parts, is also connected to the welding apparatus 1, in particular to the current source 2, via another welding line 18 so that a current circuit can be established across the arc 15.

In order to cool the welding torch 10, the welding torch 10 can be connected via a cooling circuit 19, with an inter-connected flow indicator 20, to a fluid container, in particular a water container 21, so that the cooling circuit 19, in particular a fluid pump used to pump the liquid contained in the water container 21, can be activated when the welding torch 10 is switched on, thereby enabling the welding torch 10 to be cooled.

The welding apparatus 1 also has an input and/or output device 22, by means of which a whole range of welding parameters, operating modes or welding programs of the welding apparatus 1 can be set up and retrieved. The welding parameters, operating modes or welding programs entered via the control unit 22 are then forwarded to the control system 4, from where the individual components of the welding system or welding apparatus 1 are activated and appropriate desired values pre-defined for regulation and control purposes.

In the embodiment illustrated as an example here, the welding torch 10 is also connected to the welding apparatus 1 or welding system by means of a hose pack 23. The individual lines from the welding apparatus 1 to the welding torch 10 are disposed in the hose pack 23. The hose pack 23 is connected by means of a connector device 24 to the welding torch 10, whilst the individual lines in the hose pack 23 are connected to the individual contacts of the welding apparatus 1 by means of connecting sockets and plug connectors. To relieve tension on the hose pack 23, the hose pack 23 is connected via a tension-relieving device 25 to a housing 26, in particular the basic housing of the welding apparatus 1. Naturally, it would also be possible for the connector device 24 to be used for the connection to the welding apparatus 1 as well.

Basically, it should be pointed out that not all of the components mentioned above necessarily have to be used or employed for the different welding processes or welding apparatuses 1, such as WIG apparatus or MIG/MAG apparatuses or plasma welding apparatuses, for example. This being the case, it may be that an air-cooled welding torch 10 is used as the welding torch 10.

The first control unit 22 may have input and/or output devices, by means of which a whole range of welding parameters and operating modes of the welding apparatus 1 can be set up. Accordingly, the input data is forwarded to a microprocessor controller 27 comprising a memory device 28 and the power component 3. The power component 3 then supplies the individual components of the welding apparatus 1 on the basis of the parameters pre-defined by the control system 4 or the microprocessor controller 27.

In one embodiment, the microprocessor controller 27 and/or the first control unit 22 may be provided in the form of an external standard computer, connected by means of appropriate interfaces. The first control unit 22 may likewise be provided separately from the welding apparatus 1 and connected to it by means of cables or wirelessly.

At this stage, it should be pointed out that the method proposed by the invention and the control system 4 are suitable not only for controlling welding processes operated by feeding the welding rod as an electrode, as is the case with MIG or MAG processes for example, but also for welding process using a permanent electrode, such as WIG processes for example.

A second control unit 29 is provided at the welding torch 10. In the most basic embodiment of the invention, this second control unit 29 is a push-button element 30 of a type known from the prior art. The advantage of this is that standard, commercially available single-button torches can be used, thereby incurring very little in the way of extra costs and offering a high degree of reliability due to its simple design.

The risk of incorrect operation, such as can occur with multi-button torches involving control crosses or complex operating menus for example, is low.

Via a cable connection 31, in particular a two-terminal cable which may be integrated in the hose pack 23, the start signals or the control signals generated by the user by means of the push-button element 30 may be transmitted between the second control unit 29, in other words the welding torch 10, and the control system 4, and a one-button torch of the type known from the prior art is therefore suitable for this purpose.

The signals transmitted from the second control unit 31, in particular the push-button element 30, to the control system 4 are processed and evaluated by means of an element 32 contained in the microprocessor controller 27, following which the appropriate commands are transmitted to the components of the welding apparatus 1, such as the memory device 28, power component 3, etc.

FIG. 2 is a block diagram illustrating the control system 4.

The control system 4 comprises the first control unit 22, the microprocessor controller 27, and the second control unit 29, the second control unit 29 being provided in the form of a simple one-button welding torch 10, which may be connected via two control lines or a cable connection 31 to the welding apparatus 1, in particular the element 32.

The microprocessor controller 27 comprises the memory device 28 and the power component 3 to which the different cables for the other components can be connected, as well as an element 32 for evaluating signals transmitted by the second control unit 29, in particular a start signal and/or a control signal.

It is of advantage if the second control unit 29 also has a visual and/or acoustic output device 33 for warning messages and/or information in addition to the push-button element 30.

The output device 33 may be provided in the form of LEDs, in which case the user will be able to obtain information about the currently set welding program directly at the welding torch 10 and will easily be able to see whether the control operation was correctly recognized and run by the element 32.

The welding parameters entered by means of the first control unit 22, such as the current intensity, a frequency or pulse time of the welding current, the rod feed rate or similar parameters, may be stored in the memory device 28 and selected or activated by means of the second control unit 29, in other words by means of the push-button element 30 (not illustrated in FIG. 2) as and when necessary and transmitted to the power component 3, thereby enabling the components connected to it, such as the rod feed device 11, for example, to be activated and the welding current set accordingly.

FIG. 3 is a schematic diagram of the memory of the memory device 28.

Schematically illustrated are the welding parameters stored in the memory device 28, organized in parameter groups 34.

The individual welding parameters may be organized in parameter groups 34, each of which may define a separate welding job 35, 36, 37, 38, 39, which is stored in the memory device 28.

At this stage, it should be pointed out that the memory layout illustrated in FIG. 3 represents but one possible example of how welding parameters are stored and this should not be construed as restricting the scope of the invention in any way.

Via the second control unit 29, when the welder generates an appropriate control signal by means of the second control unit 29, the welding process is not started and instead, the welding jobs 35 to 39 stored in the memory device 28 can be individually selected for the specific application. For example, welding job 35 may define a welding current of 150 A and a rod feed rate of 5 m/min, for example, whereas welding job 36 may incorporate settings of 200 A and 6 m/min wire feed rate and welding job 37 in turn sets the welding current intensity to 250 A and the rod feed rate to 6.5 m/min.

A control signal of the second control unit 29 is evaluated by the element 32 to ascertain its frequency and/or the duration for which the push-button was depressed and, depending on the result of the evaluation, the welding process is started or a switch can be made from the current welding job 35 with its set parameters to the next welding job 36 stored in the memory device 28.

The criterion as to whether the welding operation is initiated or a selection mode is retrieved for selecting the welding jobs 35 to 39 can be fixed in such a way that in order to start the welding process by means of the microprocessor controller 27, a longer time of depressing the push-button element 30 is defined than for switching to the selection mode i.e. the element 32 evaluates the signal transmitted from the push-button element 30 and ascertains whether there is a start signal for initiating the welding process or a control signal for switching the welding job 35 to 39. Basically, it should be pointed out that the element 32 can be provided in the form of software in the microprocessor controller and the signal from the push-button element 30 can be evaluated on the basis of the length or duration of the signal so that a corresponding correlation can be assigned to a control signal or a start signal.

The individual welding jobs 35 to 39 stored in the memory device 28 may be stored separated from one another by empty jobs or empty groups 40, so that several job groups 41, 42 may be created. This makes it possible, by means of an appropriate control sequence, in other words by generating several control signals at the second control unit 29, for example two brief depressions of the push-button element 30, to skip from the current welding job 35 in job group 41 via the next empty group 40 stored in the memory device 28 to welding job 38 in job group 42, after which welding can then be initiated on the basis of these parameters or this parameter group 34 by depressing the push-button for a time longer than that used for the preceding selection.

For the purpose of the invention, it is also possible to select between the individual welding jobs 35 to 39 or job groups 41, 42 during welding, which means that other welding parameters can be set without interruption in the event of changes in the sheet thickness, for example.

For the purpose of the invention, it is likewise possible to depress the push-button element 30 at the second control unit 29 briefly several times in order to jump back from the current welding job 39, for example, to welding job 38 following the preceding empty group 40. As a result, a welding process defined between the two empty groups 40, for example fixed by the welding jobs 38 and 39, can be repeated several times, making it easy to switch between the welding jobs 38 and 39. Basically, it may be said that the welding jobs 35 to 39 in the individual job groups 41, 42 are processed consecutively in a loop and when the last welding job 37 or 39 or a job group 41 or 42 is reached, the first welding job 35 or 38 of this job group 41 or 42 is retrieved.

Irrespective of which welding job 35 to 39 is the current one at any given time and thus deployed by the microprocessor controller 27 so that the components of the welding apparatus 1, such as the power component 3, are being controlled and regulated on the basis of the stored data, an appropriate control sequence can be run at the second control unit 29 to retrieve the first welding job 35 or the first parameter group 34 respectively stored in the memory device 28, and welding may be initiated on the basis of these parameters.

The number of parameter groups 34 and welding jobs 35 to 39 stored in the memory device 28 depends solely on the available memory and is limited solely by the requirements of the user.

The parameters and values set for and contained in the individual welding jobs 35 to 39 may be checked by the microprocessor controller 27 at the time they are input via the first control unit 22 to ascertain whether pre-defined threshold values and values and ratios correlated by the individual parameters have been complied with, and a visual and/or acoustic warning message may be emitted by the first or second control unit 22, 29 if necessary.

As proposed by the invention, the second control unit 29 may have a visual and/or acoustic output device for warning messages and/or information, thereby alerting the welder accordingly if he has made an operating error or enabling the currently selected operating mode of the welding apparatus 1, for example the currently selected welding job 35 to 39, to be displayed.

Due to the fact that the individual welding jobs 35 to 39 and the empty groups 40 are stored in the memory device 28 so that they can be clearly identified, the sequence of the welding jobs 35 to 39 illustrated in FIG. 3 can be easily reorganized or redefined by means of the first control unit 22.

As proposed by the invention, it is also possible for job group 41, for example, to be defined as a standard welding process with a fixed current intensity and rod feed rate and job group 42, for example, to pre-set a pulsed welding process with a specific pre-defined frequency or pulse duration and intensity of welding current, so that when a switch is made from job group 41 to job group 42, for example by means of a medium-length button pulse or signal duration compared with the start pulse and the pulse for switching through the individual welding jobs 35 to 39, a switch can be made to pulsed mode before starting the welding operation and vice versa.

As a result of these simple control sequences, the user is in a position to make an optimum adaptation of the welding apparatus 1 to his requirements. At the same time, a simple and inexpensive welding torch 10 can be used.

However, instead of using the empty jobs 40, it is also possible to provide a welding job 35 to 39 with an indicator for a separator signal for example, so that the microprocessor controller 27 will recognize a skip marker for the job groups 41, 42 similar to an empty job 40.

With regard to the possible control signals generated by the second control unit 29, a comparison is run in the element 32 between control signals already stored in the memory device 28 by the user, so that a plurality of commands can be detected, thereby permitting a comprehensive and very variable control or selection of the individual welding jobs 35 to 39. When the welding apparatus 1 is switched on, the user can set the definition of the control signals and the start signal and train the welding apparatus. Accordingly, different signal definitions may be stored for different users, although the relevant user will have to log in after switching the welding apparatus 1 on in order to load his data.

Once the desired welding job 35 to 39 has been selected using the method described above, the welding operation with the desired welding job 35 to 39 can be initiated by means of a defined start signal, for example with a pulse duration of 0.5 sec.

The duration of the pulses for the start and control signal and the expressions “brief” or “medium-length” used in connection with them were selected to make it easier to explain the invention and their exact duration can be set individually to suit the requirements of the user.

The embodiments illustrated as examples represent possible design variants of the control system 4 and the method and it should be pointed out at this stage that the invention is not specifically limited to the design variants specifically illustrated, and instead the individual design variants may be used in different combinations with one another and these possible variations lie within the reach of the person skilled in this technical field given the disclosed technical teaching. Accordingly, all conceivable design variants which can be obtained by combining individual details of the design variants described and illustrated are possible and fall within the scope of the invention.

For the sake of good order, finally, it should be pointed out that, in order to provide a clearer understanding of the structure of the welding apparatus 1 and the control system 4 system, they and their constituent parts are illustrated to a certain extent out of scale and/or on an enlarged scale and/or on a reduced scale.

The objective underlying the independent inventive solutions may be found in the description.

Above all, the individual embodiments of the subject matter illustrated in FIGS. 1; 2; 3 constitute independent solutions proposed by the invention in their own right. The objectives and associated solutions proposed by the invention may be found in the detailed descriptions of these drawings.

### List of Reference Numbers

1 Welding apparatus 26 Housing
2 Current source 27 Microprocessor controller
3 Power component 28 Memory device
4 Control system 29 Control unit
5 Switching element 30 Push-button element
6 Control valve 31 Cable connection
7 Supply line 32 Element
8 Gas 33 Output device
9 Gas storage 34 Parameter group
10 Welding torch 35 Welding job
11 Rod feed device 36 Welding job
12 Supply line 37 Welding job
13 Welding rod 38 Welding job
14 Supply reel 39 Welding job
15 Arc 40 Empty group
16 Workpiece 41 Job group
17 Welding line 42 Job group
18 Welding line
19 Coolant circuit
20 Flow indicator
21 Water container
22 Control unit
23 Hose pack
24 Connector device
25 Tension-relieving device

1. Method of controlling a welding apparatus (1), whereby individual welding parameters, such as a current intensity, a rod feed rate, a welding process, a frequency and/or pulse time of a welding current etc., for example, can be set by the user in the form of a welding job (35 to 39) for a specific welding process by means of a first control unit (22) hard-wired to or integrated in the welding apparatus (1), and several such welding jobs (35 to 39) can be stored in a memory device (28) and, by selecting a welding job (35 to 39) using the first control unit (22), the welding apparatus (1) and the components of the welding system, such as a power component (3), a rod feed system or a rod feed device (11) etc., for example, can be activated on the basis of the parameters stored therein by means of a control system (4), in particular a microprocessor controller (27), and when a second control unit (29) is operated, in particular a push-button element (30) disposed on the welding torch (10), a start signal is sent to the control system (4) in order to initiate the welding operation, wherein the start signal or a control signal is generated by the push-button element (30) of the second control unit (29), in other words of the welding torch (10), and before starting the welding operation, a selection or switch is made between the individual stored welding jobs (35 to 39) by means of the control signal and/or the start-up of the welding operation can be run by generating the start signal via the same push-button element (30).

2. Method according to claim 1, wherein the parameters for an individual welding job (35 to 39) are organized in parameter groups (34) and the different welding jobs (35 to 39) are stored in the memory device (28) in a fixed sequence.

3. Method according to claim 1, wherein the welding jobs (35 to 39) are stored in the memory device (28) so that they are clearly identified.

4. Method according to claim 1, wherein the welding jobs (35 to 39) are organized in individual job groups (41, 42) from which at least one welding job (35 to 39) can be retrieved.

5. Method according to claim 1, wherein the job groups (41, 42) containing one or more welding jobs (35 to 39) are stored in the memory device (28) so that they are separated from one another by means of empty groups (40) or empty jobs, in other words a welding job (35 to 39) in which no parameters have been set.

6. Method according to claim 1, wherein at the end of a job group (41, 42), the last welding job (35 to 39) is stored in the memory device (28) with an indicator for a separator signal.

7. Method according to claim 1, wherein the curve of the output signal of the push-button, in particular the push-button element (30), is used to define the control signal and the start signal on the basis of its frequency and/or its duration.

8. Method according to claim 7, wherein a comparison is run between the output signal generated by the push-button or push-button element (30) and several possible control signals previously set up in the memory device (28) and the start signal on the basis of their frequency and/or their duration.

9. Method according to claim 1, wherein the start signal for starting the welding process is defined by a longer depression of the push-button than the control signal for selecting the welding job (35 to 39).

10. Method according to claim 9, wherein, on an appropriate control signal, in particular if the push-button element (30) is depressed for a shorter time, the next welding job (35 to 39) in the sequence is selected from the memory device (28).

11. Method according to claim 9, wherein, on an appropriate control signal, after the last welding job (35 to 39) stored in the memory device (28), the first welding job (35 to 39) stored in this job group (41, 42)is selected.

12. Method according to claim 9, wherein, on an appropriate control signal, in particular if the push-button element (30) is depressed for a medium length of time, the next job group (41, 42) in the sequence after the last empty group (40) or empty job is selected from the memory device (28).

13. Method according to claim 9, wherein, on an appropriate control signal, the next job group (41, 42) in the sequence after the preceding empty group (40) is selected from the memory device (28).

14. Method according to claim 9, wherein, on an appropriate control signal, the first job group (41, 42) stored in the memory device (28) is selected.

15. Method according to claim 1, wherein any number of jobs (35 to 39) can be defined by the user in a job group (41, 42), and likewise any number of job groups (41, 42) with a different number of welding jobs (35 to 39) stored in them can be set by the user.

16. Method according to claim 1, wherein a check is run on the selected welding jobs (35 to 39) by the microprocessor controller (27) to ensure that threshold values of the individual parameters have been complied with and a visual and/or acoustic warning is message is emitted by the first and/or second control unit (22, 29) if necessary.

17. Method according to claim 1, wherein the parameters or the parameter group (21) of the respective welding job (35 to 39) selected are displayed by the first and/or second control unit (22, 29).

18. Method according to claim 1, wherein during a welding operation, a selection and switch can be made between the individual welding jobs (35 to 39) by means of the control signal generated by the second control unit (29).

19. Control system (4) for a welding apparatus, comprising a first control unit (22), a microprocessor controller (27), comprising a memory device (28) and a power component (3), and the different parameters can be set in the form of welding jobs (35 to 39) by means of the first control unit (22) and the welding apparatus (1) can be activated by the power component (3) on the basis of these parameters, and a second control unit (29) on which a push-button element (30) is disposed for generating a start signal, in particular for running the method according to claim 1, is provided on the welding torch (10) of the welding apparatus (1) which is hard-wired to the microprocessor controller (27), wherein the microprocessor controller (27) has an element (32) for evaluating a control signal generated by the second control unit (29) before starting the welding operation, and the second control unit (29) for switching the welding jobs (35 to 39) and for starting the welding process is nothing more than the push-button element (30).

20. Control system (4) according to claim 19, wherein the parameters for the welding jobs (35 to 39) are stored in the memory device (28) in parameter groups (21).

21. Control system (4) according to claim 19, wherein the individual welding jobs (35 to 39) are separated from one another by empty groups (40).

22. Control system (4) according to claim 1, wherein the second control unit (29) has a visual and/or acoustic output device (33) for warning messages and/or information.

23. Control system (4) according to claim 22, wherein the visual output device (33) is provided in the form of one or more control lamps, for example LEDs.

24. Control system (4) according to claim 22, wherein the visual output device (33) is provided in the form of a display, for example an LCD.

25. Control system (4) according to claim 1, wherein the second control unit (29), in particular the welding torch (10), is connected to the control system (4) via a two-terminal electric cable.

26. Control system (4) according to claim 19, wherein the first control unit (22) has an input device, for example in the form of a key pad, as well as a visual and/or acoustic output device, for example in the form of a display, for warning messages and/or information and is hard-wired to the microprocessor controller (1 5).

27. Control system (4) according to claim 19, wherein the first control unit (22) and the microprocessor controller (27) are provided in the form of a standard computer, separate from the welding apparatus (1), via an appropriate interface.

28. Use of the method according to claim 1 as a means of controlling a MIG, MAG or WIG welding apparatus.
